(19) United States
(12) Patent Application Publication
(10) Pub. No.: US 2007/0256656 A1
(43) Pub. Date: Nov. 8, 2007

(54) Device to Improve the Performances of a Spark Plug for Internal Combustion Engine, Two or Four Strokes

(76) Inventor: Yngve Jakobsen, Peille (FR)

Correspondence Address: YOUNG & THOMPSON, 745 SOUTH 23RD STREET, 2ND FLOOR, ARLINGTON, VA, 22202, US

(21) Appl. No.: 11/792,579

(22) PCT Filed: Oct. 17, 2005
(86) PCT No.: PCT/FR05/02564

§ 371 Date: Jun. 8, 2007

(30) Foreign Application Priority Data
Dec. 9, 2004 (FR) 0413114

(51) Int. Cl. F02P 3/00

(52) U.S. Cl. 123/146.5 R

(57) ABSTRACT

A device to improve performance of a spark plug for a two or four stroke internal combustion engine, in order to reduce exhaust pollution, facilitate starting, increase the engine performances and reduce the fuel consumption.

The invention relates to a device for creating a circulation of the fuel mixture inside the body via oblique venture shaped holes (1), crossing the spark plug body base (2), a crossing hole (3) which is conical on its upper part on the negative electrode (4), in order to obtain a more homogeneous, broader and more intense spark and to increase the gas mixture density to the spark. This device will also avoid the carbon deposit and decrease the working temperature of the spark plug (like a regulator of the thermal rating).

Device to improve the performances of a spark plug for internal combustion engine, two or four strokes

The present invention relates to a spark plug for an internal combustion engine, two or four strokes.

After reading of the U.S. Pat. No. 2,371,162 and U.S. Pat. No. 2,205,196, there are no similarities with the present patent application.

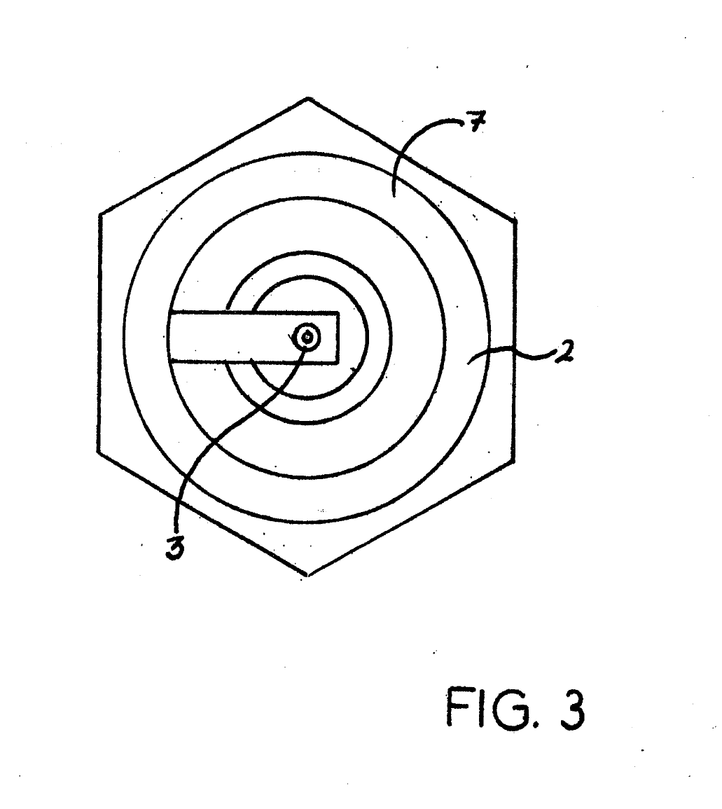

After study of the text and drawings of the U.S. Pat. No. 1,929,748 A; it represents an extremely “hot” spark plug to judge by the size of the “gas chamber” (20, FIG. 3). This was normal for engines produced in 1930 (4 to 5 of compression ratio side valves, an excessive oil consumption etc.) To manufacture a spark plug according to now a days current thermal indices (8.5 to 12 of compression ratio), and according to the patent of Mr. Little, the said “gas chamber” (20, FIG. 3) have to be decreased, even making it disappear.

Thus its principal claim indicates to realise spiral holes (21) to make the flames blasts out of the “gas chamber” through the spiral holes, for better combustion of the gas mixture, this is not possible today. Because of the distance between the spark and the bottom of the “gas chamber”, when the flame blasts out, it will be difficult to burn the total amount of the gas mixture being at the bottom of the “gas chamber”. The burned oil and carbon deposit would quickly fill up the “gas chamber”.

The patent FR2841396, concerns only one device to guide the gas mixture towards the negative electrode, but the device cannot avoid the carbon deposit on the spark plug. However, the two openings and the projection in spiral weaken the negative electrode considering its natural weak section.

A traditional spark plug keeps the gas mixture inside the body, and when the explosion occurs, the carbon deposit soots up the spark plug, and with time the performances of the spark plug degrade. The spark occurs only at one part of surfaces of the electrodes, therefore a spark with low intensity. The working heat of a traditional spark plug will get higher, causes a serious drop in performance.

The device according to the invention makes it possible to cure this disadvantage. According to a first characteristic, it includes indeed oblique venture shaped holes, crossing the body base. This makes it possible to create a circulation of the gas mixture inside the body, in order to increase the density of the gas mixture close to the ignition spot, to avoid the carbon deposit and decrease the operating temperature of the spark plug (as a regulator of the thermal rating).

The device according to the invention comprises have a second characteristic, a crossing hole which is conical on its upper part on the negative electrode acting as an “electrical vacuum” and creates a backpressure in order to improve the density of the gas mixture before the spark occurs, and to obtain a more homogeneous, broader and more intense spark and trough the hole create a flame front in order to burn the gas mixture further in the cylinder.

The device according to the invention decreases the exhaust pollution, facilitates starting, increases the performances of the engine, decreases the fuel consumption and controls the thermal rating when the engine has reached normal working temperature.

The annexed drawings illustrate the invention:

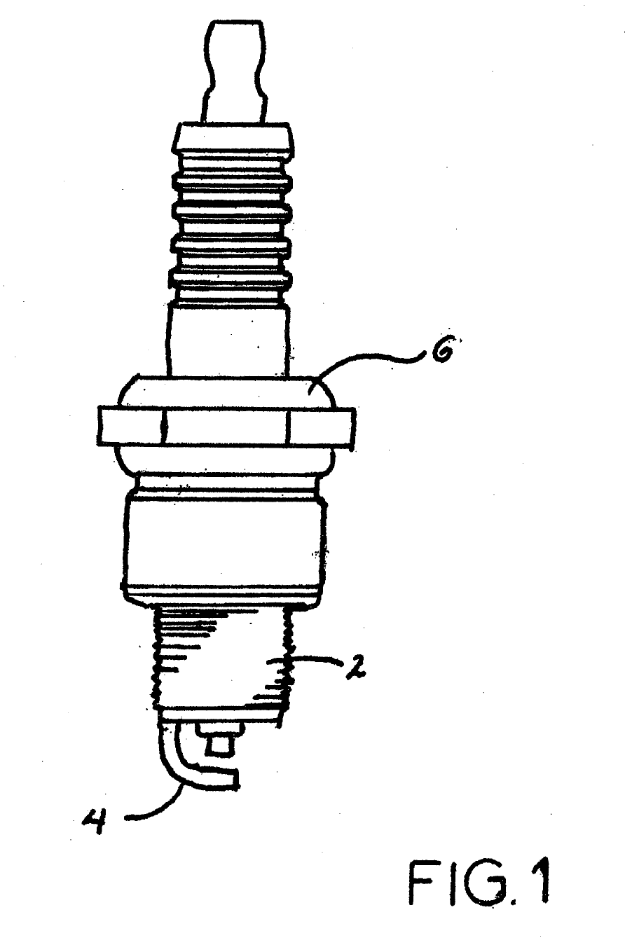

FIG. 1 represents a spark plug

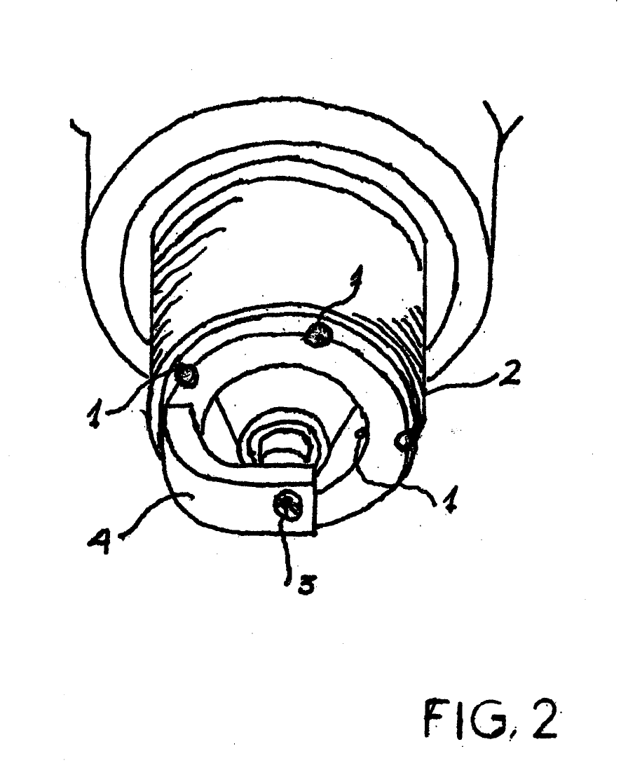

FIG. 2 represents the body of the spark plug in prospect

FIG. 3 represents a plan view of the negative electrode with a crossing hole which is oblique on its upper part

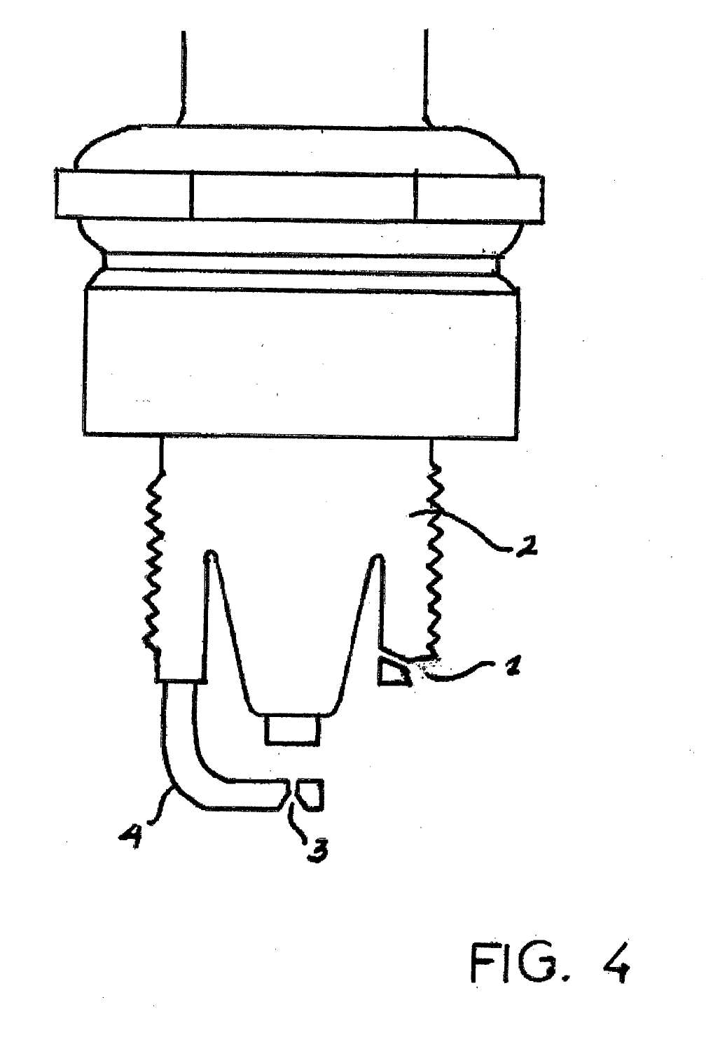

FIG. 4 represents a cut of the crossing oblique venture shaped holes on the base of the body, and the hole on the negative electrode.

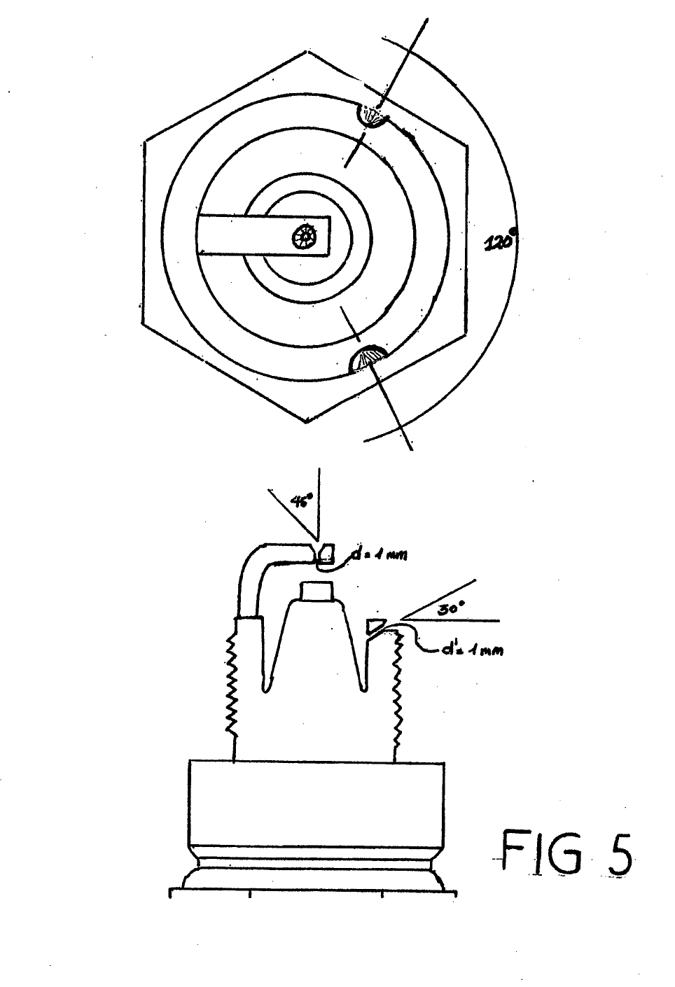

FIG. 5 represents, as an indication and non restrictive, an example of the realisation of the invention including a plurality of tilting angles of drilling.

In reference to these drawings the device comprises several oblique shaped crossing holes (1) carried out on the base of the spark plug body (2) (FIG. 2, 4) and a crossing hole (3) which is conical on its upper part on the negative electrode of the spark plug (6) (FIG. 2, 3, 4,), its seat (7) can be flat or conical.

1) Spark plug for an internal combustion engines comprising a seat (7), and a negative electrode characterized in that the base of the spark plug body is crossed by oblique venture shaped holes, which will create a circulation of the gas mixture inside the body (2), and “control” the spark plug's heat rating after the temperature setting of the engine, and that the upper part of the negative electrode have a conical shaped crossing hole (3), in order to obtain a more homogeneous, broader, more intense spark, and trough the hole create flame front in order to burn the fuel mixture further in the cylinder.

2) Spark plug according to the claim n^{o} 1 characterized in that the seat (7) can be flat or conical.
